(19) United States
(12) Patent Application Publication
(10) Pub. No.: US 2013/0012669 A1
(43) Pub. Date: Jan. 10, 2013

(54) THERMOSETTING RESIN COMPOSITION AND APPLICATION THEREOF

(76) Inventors: Chih-Hung LIN, Tainan City (TW); Chia-Hui Yu, Chiayi County (TW)

(21) Appl. No.: 13/529,106

(22) Filed: Jun. 21, 2012

(30) Foreign Application Priority Data
Jul. 4, 2011 (TW) 100123501

(51) Int. Cl. C09J 163/02; B32B 37/12

(52) U.S. Cl. 525/523; 523/400; 156/329

(57) ABSTRACT

A thermosetting resin composition includes an epoxy resin, a polyetheramine curing agent, and an epoxy silane coupling agent. The polyetheramine curing agent is in an amount less than or equal to 10 parts by weight and the epoxy silane coupling agent is in an amount more than or equal to 10 parts by weight based on 100 parts by weight of the epoxy resin.

### CROSS-REFERENCE TO RELATED APPLICATION

This application claims priority of Taiwanese Application No. 100123501, filed on Jul. 4, 2011.

### BACKGROUND OF THE INVENTION

1. Field of the Invention

This invention relates to a thermosetting resin composition, more particularly to a thermosetting resin composition having good viscosity stability and edge coating property. This invention also relates to an adhesive layer formed from the thermosetting resin composition and a display device containing the adhesive layer.

2. Description of the Related Art

A currently popular electronic display device, such as an electronic paper, a touch panel, or the like, is usually required to be slim and flexible. Therefore, it is required to use a flexible substrate, such as a substrate made of polyethylene terephthalate (PET). Additionally, the other components and adhesive for the electronic display device are also required to be thin and flexible. The adhesive used for the electronic display device may be generally classified into a photo-curable resin composition and a thermal-curable resin composition, both of which have good flexibility, moisture resistance, mechanical strength, etc.

In the resin composition commonly used for the electronic display device, the photo-curable resin composition usually has inferior adhesiveness with the PET substrate. Therefore, the thermal-curable resin composition is more commonly used for the electronic display device. However, the thermal-curable resin composition has a problem in viscosity stability.

Japanese patent publication No. 11-060695 discloses a low-temperature-curable epoxy resin composition with improved adhesiveness and moisture resistance. The resin composition includes an epoxy resin, a polyamine curing agent, and at least one tertiary amine curing accelerator. The polyamine curing agent can be selected from, for example, polyetherpolyamines, such as polyoxypropylene diamine. Although the resin composition disclosed in this prior art can be cured at low temperature, it has inferior viscosity stability.

Japanese patent publication No. 07-199198 discloses a sealing material composition for assembling liquid crystal cells. The sealing material composition includes (a) a polytetramethylene ether glycol diglycidyl ether (PTMG) epoxy resin that is liquid at room temperature; (b) a bisphenol type of epoxy resin that is liquid at room temperature; (c) a tri-functional thiol compound that is liquid at room temperature; (d) a silane coupling agent; (e) titanium dioxide; and (f) amorphous silicon dioxide. The composition has good flexibility and moisture resistance after curing.

In the process for manufacturing the electronic display device, when the resin composition is laterally coated to seal the components of the electronic display device, the lateral edges of the components should be fully filled with the resin composition so as to ensure the sealing of the components. Furthermore, it is necessary to avoid overflowing of the resin composition. When the resin composition overflows, the adhesiveness of the components may be adversely affected, and the appearance of the final product may be unsatisfactory. Furthermore, the overflowed resin composition should be removed, which may raise production costs and probability of product failure. The aforesaid Japanese patent publication No. 07-199198 has such a problem of resin overflowing.

Therefore, in addition to good flexibility and mechanical properties, the thermal-curable resin composition presently used in the art should be improved in viscosity stability and edge coating property.

### SUMMARY OF THE INVENTION

Therefore, an object of the present invention is to provide a thermosetting resin composition which is superior in viscosity stability and edge coating property when used to form an adhesive layer in a display device.

According to a first aspect of this invention, there is provided a thermosetting resin composition including an epoxy resin, a polyetheramine curing agent, and an epoxy silane coupling agent. The polyetheramine curing agent is in an amount ranging from 1 to 10 parts by weight and the epoxy silane coupling agent is in an amount ranging from 10 to 50 parts by weight based on 100 parts by weight of the epoxy resin.

According to a second aspect of this invention, there is provided an adhesive layer formed by heating the thermosetting resin composition of this invention.

According to a third aspect of this invention, there is provided a display element including the adhesive layer.

According to a fourth aspect of this invention, there is provided a method for making a display element which includes the steps of: providing two substrate units; applying the thermosetting resin composition on an edge portion of at least one of the substrate units; laminating the substrate units in a manner that the thermosetting resin composition is disposed between the substrate units; and curing the thermosetting resin composition by heating.

### DETAILED DESCRIPTION OF THE PREFERRED EMBODIMENTS

The thermosetting resin composition according to the present invention includes an epoxy resin, a polyetheramine curing agent, and an epoxy silane coupling agent. In the thermosetting resin composition, the polyetheramine curing agent is in an amount ranging from 1 to 10 parts by weight based on 100 parts by weight of the epoxy resin, and the epoxy silane coupling agent is in an amount ranging from 10 to 50 parts by weight based on 100 parts by weight of the epoxy resin. Preferably, in the thermosetting resin composition, the polyetheramine curing agent is in an amount ranging from 1 to 10 parts by weight and the epoxy silane coupling agent is in an amount ranging from 10 to 50 parts by weight based on 100 parts by weight of the epoxy resin.

When the polyetheramine curing agent is in an amount less than 1 part by weight based on 100 parts by weight of the epoxy resin, the thermosetting resin composition may have inferior edge coating property. On the other hand, when the polyetheramine curing agent is in an amount more than 10 parts by weight based on 100 parts by weight of the epoxy resin, the thermosetting resin composition may have inferior viscosity stability.

When the epoxy silane coupling agent is in an amount less than 10 parts by weight based on 100 parts by weight of the epoxy resin, the thermosetting resin composition may have inferior viscosity stability. On the other hand, when the epoxy silane coupling agent is in an amount more than 50 parts by weight based on 100 parts by weight of the epoxy resin, the thermosetting resin composition may have inferior edge coating property.

More preferably, the polyetheramine curing agent is in an amount ranging from 2 to 9 parts by weight and the epoxy silane coupling agent is in an amount ranging from 12 to 45 parts by weight based on 100 parts by weight of the epoxy resin. Most preferably, the polyetheramine curing agent is in an amount ranging from 3 to 8 parts by weight and the epoxy silane coupling agent is in an amount ranging from 15 to 40 parts by weight based on 100 parts by weight of the epoxy resin.

### Epoxy Resin:

The epoxy resin suitable for the present invention is selected from an epoxy resin having two functional groups and an epoxy resin having three or more functional groups.

Examples of the epoxy resin having two functional groups include, but are not limited to, bisphenol A epoxy resin, bisphenol F epoxy resin, biphenyl epoxy resin, naphthalene epoxy resin, dicyclopentadiene epoxy resin, oxazolidone skeleton-containing epoxy resin, and diphenyl fluorene epoxy resin. The aforesaid examples of the epoxy resin may be used alone or in admixture of two or more.

Commercially available products of the bisphenol A epoxy resin suitable for the present invention include, but are not limited to, Epicoat 827 (epoxy equivalency: 180-190), Epicoat 828 (epoxy equivalency: 184-194), Epicoat 1001 (epoxy equivalency: 450-500), and Epicoat 1004 (epoxy equivalency: 875-975) manufactured by Yuka Shell Epoxy; YD128 (epoxy equivalency: 184-194) manufactured by Tohto Kasei Co., Ltd.; Epiclon 840 (epoxy equivalency: 180-190), Epiclon 850 (epoxy equivalency: 184-194), Epiclon 855 (epoxy equivalency: 183-193), Epiclon 860 (epoxy equivalency: 230-270), and Epiclon 1050 (epoxy equivalency: 450-500) manufactured by Dainippon Ink and Chemicals Incorporated; ELA 128 (epoxy equivalency: 230-270) manufactured by Sumitomo Chemical; and DER 331 (epoxy equivalency: 184-190, viscosity at 25° C.: 12000-15000 cps) manufactured by Dow Chemical.

Commercially available products of the bisphenol F epoxy resin suitable for the present invention include, but are not limited to, Epicoat 807 (epoxy equivalency: 160-175) manufactured by Yuka Shell Epoxy; and Epiclon 830 (epoxy equivalency: 165-185) manufactured by Dainippon Ink and Chemicals Incorporated.

Commercially available products of the biphenyl epoxy resin suitable for the present invention include, but are not limited to, YX4000 (epoxy equivalency: 180-192) manufactured by Yuka Shell Epoxy. Commercially available products of the naphthalene epoxy resin suitable for the present invention include, but are not limited to, HP-4032 (epoxy equivalency: 140-150) manufactured by Dainippon Ink and Chemicals Incorporated. Commercially available products of the dicyclopentadiene epoxy resin suitable for the present invention include, but are not limited to, EXA-7200 (epoxy equivalency: 260-285) manufactured by Dainippon Ink and Chemicals Incorporated. Commercially available products of the oxazolidone skeleton-containing epoxy resin suitable for the present invention include, but are not limited to, AER4152 (average epoxy equivalency: 330) and XAC4151 (average epoxy equivalency: 420) manufactured by Asahi Kasei Epoxy Co., Ltd. Commercially available products of the diphenyl fluorene epoxy resin suitable for the present invention include, but are not limited to, EPON HPT1079 (epoxy equivalency: 250-260) manufactured by Oil Recovery Shell Epoxy Co.

Examples of the tri- or tetra-functional epoxy resin include, but are not limited to, phenol novolak type epoxy resin, cresol novolak type epoxy resin, glycidyl amine epoxy resin, and glycidyl ether epoxy resin. The aforesaid examples of the epoxy resin may be used alone or in admixture of two or more.

Examples of the glycidyl amine epoxy resin include, but are not limited to, triglycidyl amine epoxy resin and tetraglycidyl amine epoxy resin. Examples of the triglycidyl amine epoxy resin include, but are not limited to, triglycidyl amino cresol epoxy resin and triglycidyl aminophenol epoxy resin. Examples of the tetraglycidyl amine epoxy resin include, but are not limited to, tetrakis (glycidyloxyphenyl)ethane epoxy resin.

Examples of the glycidyl ether epoxy resin include, but are not limited to, triglycidyloxy methane epoxy resin and tetraglycidyl ether diaminodiphenylmethane epoxy resin.

Commercially available products of the phenol novolak type epoxy resin suitable for the present invention include, but are not limited to, Epicoat 152 (epoxy equivalency: 172-179) and Epicoat 154 (epoxy equivalency: 176-184) manufactured by Yuka Shell Epoxy Co.; DER438 (epoxy equivalency: 176-181) manufactured by Dow Chemical; and EPN1138 (epoxy equivalency: 176-181) and EPN1139 (epoxy equivalency: 172-179) manufactured by Ciba-Geigy.

Commercially available products of the cresol novolak type epoxy resin suitable for the present invention include, but are not limited to, ESCN220L (epoxy equivalency: 200-230) manufactured by Sumitomo Chemical; Epicoat 180S65 (epoxy equivalency: 205-220) manufactured by Yuka Shell Epoxy; and ECN1273 (average epoxy equivalency: 225) manufactured by Ciba-Geigy.

Commercially available products of the triglycidyl aminophenol or triglycidyl aminocresol epoxy resin suitable for the present invention include, but are not limited to, ELM100 manufactured by Sumitomo Chemical; MY0510 manufactured by Ciba-Geigy; and Epicoat 630 manufactured by Yuka Shell Epoxy.

Commercially available products of the tetraglycidyl ether diaminodiphenylmethane epoxy resin suitable for the present invention include, but are not limited to, ELM434 manufactured by Sumitomo Chemical; YH434L manufactured by Tohto Kasei Co., Ltd.; and Epicoat 604 manufactured by Yuka Shell Epoxy.

Preferably, commercially available products of epoxy resin suitable for the present invention include Epicoat 828 (epoxy equivalency: 184-194), Epicoat 1001 (epoxy equivalency: 450-500), and YX4000 (epoxy equivalency: 180-192) manufactured by Yuka Shell Epoxy; and Epiclon 830 (epoxy equivalency: 168-185) manufactured by Dainippon Ink and Chemicals Incorporated.

### Polyetheramine Curing Agent:

Preferably, the polyetheramine curing agent suitable for the present invention is selected from: a curing agent of formula (I),

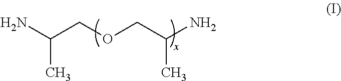

wherein
x is an integer ranging from 1 to 60, and preferably from 2 to 60;
   a curing agent of formula (II),

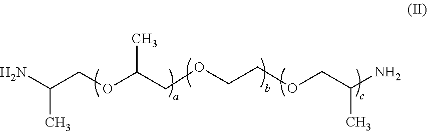

wherein

a, b, and c are respectively a positive integer,

1≦b≦50, and

1≦a+c≦10, preferably 2≦a+c≦10;

a curing agent of formula (III):

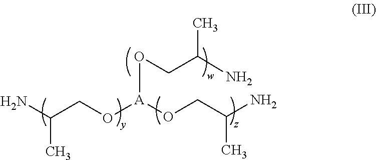

wherein
A represents a triol core having 3 to 6 carbon atoms and capable of oxyalkylation, and preferably a triol core having 3 to 6 carbon atoms and capable of propoxylation,
w, y, and x are respectively a positive integer, and an average of a sum of w, y, and x ranges from 4 to 100; and
   combinations thereof.

Commercially available products of the curing agent of formula (I) include, but are not limited to, Jeffamines® D-series products manufactured by Huntsman, such as D-230 (average molecular weight: 230, and x=2.5), D-400 (average molecular weight: 400, and x=6.1), D-2000 (average molecular weight: 2000, and x=33), and D-4005 (average molecular weight: 4000, and x=60), or the like.

Commercially available products of the curing agent of formula (II) include, but are not limited to, Jeffamines® ED-series products manufactured by Texaco Chemical, such as ED-600 (average molecular weight: 600, a value of a+c is about 2.5, and a value of b is about 8.5), ED-900 (average molecular weight: 900, a value of a+c is about 2.5, and a value of b is about 15.5), ED-2001 (average molecular weight: 2000, a value of a+c is about 2.5, and a value of b is about 40), and ED-4000 (average molecular weight: 4000, a value of a+c is about 2.5, and a value of b is about 85), or the like.

Commercially available products of the curing agent of formula (III) include, but are not limited to, Jeffamines® T-series products manufactured by Texaco Chemical, such as T-403 (average molecular weight: 400, a value of w+y+z is about 5.3, and A represents a trimethylolpropane core), T-3000 (average molecular weight: 3000, a value of w+y+z is about 50, and A represents a trimethylolpropane core), and T-5000 (average molecular weight: 5000, a value of w+y+z is about 86, and A represents a glycerol core).

The weight average molecular weight of the polyetheramine curing agent suitable for the present invention ranges preferably from 200 to 5000, more preferably from 200 to 4500, and most preferably from 200 to 4000.

### Epoxy Silane Coupling Agent:

Preferably, the epoxy silane coupling agent suitable for the present invention is selected from β-(3,4-epoxycyclohexyl)-ethyltrimethoxysilane, β-(3,4-epoxycyclohexyl)-ethyltriethoxysilane, β-(3,4-epoxycyclohexyl)-ethyldimethoxymethylsilane, β-(3,4-epoxycyclohexyl)-ethylethyldiethoxysilane, β-(3,4-epoxycyclohexyl)-ethyldiethoxyethylsilane, γ-glycidoxyhydroxypropyltrimethoxysilane, γ-glycidoxyhydroxypropylmethyldiethoxysilane, γ-glycidoxyhydroxypropyltriethoxysilane, γ-glycidoxypropyltrimethoxysilane, γ-glycidoxypropylmethyldimethoxysilane, γ-glycidoxypropyldimethylmethoxysilane, γ-glycidoxypropylmethyldiethoxysilane, γ-glycidoxypropylethyldiethoxysilane, γ-glycidoxypropyldimethyldiethoxysilane, γ-glycidoxypropyltriethoxysilane], and combinations thereof.

More preferably, the epoxy silane coupling agent suitable for the present invention is selected from β-(3,4-epoxycyclohexyl)-ethyltrimethoxysilane (for example, KBM-303 commercially available from Shin-Etsu Chemical Co., Ltd.), γ-glycidoxypropyltrimethoxysilane (for example, KBM-403 commercially available from Shin-Etsu Chemical Co., Ltd.), γ-glycidoxypropylmethyldiethoxysilane (for example, KBE-402 commercially available from Shin-Etsu Chemical Co., Ltd.), γ-glycidoxypropyltriethoxysilane (KBE-403 commercially available from Shin-Etsu Chemical Co., Ltd.), and combinations thereof.

### Filler:

The thermosetting resin composition of the present invention can further include a filler as long as the desirable properties thereof are not adversely affected. The filler may be used in an amount ranging generally from 10 to 80 parts by weight, preferably from 15 to 70 parts by weight, and more preferably from 20 to 60 parts by weight, based on 100 parts by weight of the epoxy resin. When the amount of the filler is excessive, the mechanical property and flexibility of the thermosetting resin composition after curing may be reduced.

The filler can be organic or inorganic, and is preferably inorganic.

The filler suitable for the present invention is in a form of micro powder having an average particle size ranging from 0.005 to 40 μm so as to enhance the flexibility and adhesiveness of the thermosetting resin composition after curing. Preferably, the average particle size of the micro powder ranges from 0.005 to 20 μm. More preferably, the average particle size of the micro powder ranges from 0.005 to 10 μm. Most preferably, the average particle size of the micro powder ranges from 0.005 to 5 μm.

Examples of the inorganic filler suitable for the present invention include, but are not limited to, silica (SiO₂), alumina (Al₂O₃), titania (TiO₂), magnesia (MgO),tantalum oxide (Ta₂O₅), zirconia (ZrO₂), silicon nitride (Si₃N₄), barium titanate (BaO.TiO₂), barium carbonate (BaCO₃), lead titanate (PbO.TiO₂), lead zirconate titanate (PZT), lead lanthanum zirconate titanate (PLZT), gallate (Ga₂O₃), spinel (MgO.Al₂O₃), mullite (3Al₂O₃.2SiO₂), cordierite (2MgO.2Al₂O₃. 5SiO₂),talc (3MgO.4SiO₂.H₂O), aluminum titanate (TiO₂. Al₂O₃), Yttria-Zirconia (Y₂O₃.ZrO₂), Bariumsilicate (BaO. 8SiO₂), boron nitride (BN), calcium carbonate (CaCO₃), calcium sulfate (CaSO₄), zinc oxide (ZnO), magnesium titanate (MgO.TiO₂), barium sulfate (BaSO₄), organobentonite, carbon, silica gel, mica, or the like. The aforesaid examples of the filler can be used alone or in admixture of two or more. More preferably, the inorganic filler is silica.

The inorganic filler can be in a form of particles with or without surface treatment. The surface treatment includes methoxylation, trimethylsilylation, octylsilylation, or silicone oil treatment.

### Other Curing Agent:

Other curing agents, such as polyamines, anhydrides, organic acids, or the like, can be added to the thermosetting resin composition of the present invention as long as the desirable properties of the thermosetting resin composition are not impaired.

### Additives:

Additives, such as polymerization inhibitor, modifier, defoaming agent, colorant, light stabilizer, ultraviolent absorber, antistatic agent, or the like, can be added to the thermosetting resin composition of the present invention as long as the desirable properties of the thermosetting resin composition are not impaired. The additives may be used alone or in admixture of two or more.

Examples of the polymerization inhibitor suitable for the present invention include, but are not limited to, hydroquinone, benzoquinone, 4-(tert-butyl)catechol, 2,6-di-tert-butyl-4-methylphenol, or the like. The polymerization inhibitor is used in an amount ranging preferably from 0.01 to 10 parts by weight based on 100 parts by weight of the epoxy resin.

Examples of the modifier suitable for the present invention include, but are not limited to, leveling agent, or the like. The leveling agent is used in an amount ranging preferably from 0.01 to 10 parts by weight based on 100 parts by weight of the epoxy resin.

Examples of the defoaming agent suitable for the present invention include, but are not limited to, silicone oil, fluorocarbon oil, carboxylic polymer, or the like. The defoaming agent is used in an amount ranging preferably from 0.001 to 5 parts by weight based on 100 parts by weight of the epoxy resin.

Examples of the colorant suitable for the present invention include, but are not limited to, inorganic pigment, organic pigment, and a combination thereof. The organic pigment is miscible with the thermosetting resin composition of the present invention. The colorant is used in an amount ranging preferably from 0.01 to 50 parts by weight based on 100 parts by weight of the epoxy resin.

An adhesive layer can be formed by heating the thermosetting resin composition of the present invention at a temperature preferably from 60 to 100° C. for a period ranging preferably from 30 to 60 minutes.

A display device according to the present invention includes the aforesaid adhesive layer.

The display device can be made by providing two substrate units, laterally coating the edge portion of at least one of the substrate units with the thermosetting resin composition of the present invention, and laminating and heating the two substrate units with the thermosetting resin composition disposed therebetween.

The substrate unit suitable for the display device can be any of the substrate units commonly used in the art of the display device. Examples of the display device include, but are not limited to, electronic parts, electronic products, optical parts, and optical products. Preferably, the display device is an electronic paper. The thermosetting resin composition of the present invention can be used as a sealant for the electronic paper so as to seal the substrate units of the electronic paper. The substrate unit can be a substrate unit for the electronic paper of the microcapsule electrophoresis, microcup electrophoresis, liquid powder, or cholesteric liquid crystal type.

The substrate unit includes at least a substrate and a conductive layer. Preferably, the substrate is flexible. The substrate may be made of polyethylene terephthalate, polyethylene naphthalate, polyethylene, polycarbonate, polyimide, or the like.

When the thermosetting resin composition of the present invention is used as the sealant for the electronic paper, especially of the microcapsule electrophoresis type, the sealing process is conducted by laminating a front plane with a back plane, laterally coating the edge portion of the laminate with the thermosetting resin composition of the present invention, and heating the thermosetting resin composition.

The following examples are provided to illustrate the preferred embodiments of the invention, and should not be construed as limiting the scope of the invention.

### Resources of Chemicals:

### (A) Epoxy Resins:

(A-1): Bisphenol A epoxy resin (liquid): Epicoat 828 manufactured by Japan Epoxy Resins.

(A-2): Bisphenol A epoxy resin: Epicoat 1001 manufactured by Japan Epoxy Resins.

(A-3): Bisphenol F epoxy resin: Epiclon 830 manufactured by Dainippon Ink and Chemicals Incorporated.

(A-4): Biphenyl epoxy resin: YX4000 manufactured by Japan Epoxy Resins.

### (B) Polyetheramine Curing Agents:

(B-1): D-230 of Jeffamines® series products of Huntsman, a compound of aforesaid formula (I), wherein x is 2.5, molecular weight is 230, and amine equivalent is 115 g/mol

(B-2): D-400 of Jeffamines® series products of Huntsman, a compound of aforesaid formula (I), wherein x is 6.1, molecular weight is 400, and amine equivalent is 200 g/mol

(B-3): ED-2001 of Jeffamines® series products of Huntsman, a compound of aforesaid formula (II), wherein a+c is 2.5, b is about 40, molecular weight is 2000, and amine equivalent is 1000 g/mol

(B-4): T-3000 of Jeffamines® series products of Huntsman, a compound of aforesaid formula (III), wherein A is a trimethylolpropane core, w+y+z is 50, molecular weight is 3000, and amine equivalent is 1000 g/mol

### (C) Epoxy Silane Coupling Agents:

(C-1): β-(3,4-epoxycyclohexyl)-ethyltrimethoxy-Silane, KBM-303 commercially available from Shin-Etsu Chemical Co., Ltd.

(C-2): γ-glycidoxypropyltrimethoxysilane, KBM-403 commercially available from Shin-Etsu Chemical Co., Ltd.;

(C-3): γ-glycidoxypropylmethyldiethoxysilane, KBE-402 commercially available from Shin-Etsu Chemical Co., Ltd.

(C-4): γ-glycidoxypropyltriethoxysilane, KBE-403 commercially available from Shin-Etsu Chemical Co., Ltd.

### (D) Fillers:

(D-1): Silica, QF-Si-1200 commercially available from Yong-then Technomaterial Co., Ltd., particle size: 1-10 μm

(D-2):Silica, QF-Si-1400 commercially available from Yong-then Technomaterial Co., Ltd., particle size: 1-10 μm

### Example 1

### Preparation of Thermosetting Resin Composition

100 parts by weight of Epicoat 828 (an epoxy resin), 5 parts by weight of D-400 (a polyetheramine curing agent), and 20 parts by weight of KBM-303 (an epoxy silane coupling agent) were mixed evenly to obtain a thermosetting resin composition, which was then evaluated according to the following evaluation methods. The evaluation results are shown in Table 1.

### Viscosity Stability:

Viscosities of a thermosetting resin composition as prepared and after 24 hours at room temperature (i.e., 25° C.) were determined using an E-type viscometer manufactured by Toki Sangyo, Model No. TVE-22H.

◯: viscosity variation <100%

X: viscosity variation >100%

### Edge Coating Property:

A front plane plated with a PET film containing SiO₂ thereon was aligned with a back plane (i.e., an ITO glass substrate) in a manner that a gap having a height of 250 μm and a width of 2 mm was formed between the front and back planes. A thermosetting resin composition was laterally coated onto a peripheral edge portion of the laminate of the front and back planes. The time required to fully fill the gap with the thermosetting resin composition was determined, and the coating situation of the peripheral edge portion of the laminate was examined visually.
◯: Time required to fully fill the gap is less than 5 seconds, and there is no overflowing of the thermosetting resin composition
X: Time required to fully fill the gap is equal to or more than 5 seconds, and/or there is overflowing of the thermosetting resin composition

### Examples 2 to 6 and Comparative Examples 1 to 5

Examples 2 to 6 and Comparative Examples 1 to 5 were conducted in a manner identical to that of Example 1 using the components and the amounts thereof shown in Table 1. The obtained thermosetting resin compositions of Examples 2 to 6 and Comparative Examples 1 to 5 were evaluated according to the aforesaid evaluation methods. The evaluation results are shown in Table 1.

TABLE 1

| | | Examples | | | | | | | Comparative Examples | | | | |
|---|---|---|---|---|---|---|---|---|---|---|---|---|---|
| Components | | 1 | 2 | 3 | 4 | 5 | 6 | 7 | 1 | 2 | 3 | 4 | 5 |
| (A) Epoxy Resins | A-1 | 100 | | | | 50 | | 50 | 100 | 100 | 100 | 100 | 100 |
| (pbw*) | A-2 | | 100 | | | | 70 | 20 | | | | | |
| | A-3 | | | 100 | | 50 | | 30 | | | | | |
| | A-4 | | | | 100 | | 30 | | | | | | |
| (B) Polyetheramine | B-1 | | 3 | | | | | | 0.5 | | | | |
| Curing Agents | B-2 | 5 | | 1 | 5 | | 9 | | | 13 | 5 | 5 | 12 |
| (pbw) | B-3 | | | | 5 | | | 2 | | | | | |
| | B-4 | | | | | 8 | | | | | | | |
| (C) Epoxy Silane | C-1 | 20 | | | | | | 10 | | | 8 | | |
| Coupling Agents | C-2 | | 10 | 20 | | 25 | 15 | 20 | 20 | | | | 7 |
| (pbw) | C-3 | | | 30 | | | | 15 | | 20 | | | |
| | C-4 | | | | 40 | | | | | | | 52 | |
| (D) Fillers | D-1 | | 10 | | 20 | | | | | | | | |
| (pbw) | D-2 | | | 70 | 20 | | | | | | | | |
| EvaluationResults | Viscosity | ◯ | ◯ | ◯ | ◯ | ◯ | ◯ | ◯ | ◯ | X | X | ◯ | X |
| | stability | | | | | | | | | | | | |
| | Edge Coating | ◯ | ◯ | ◯ | ◯ | ◯ | ◯ | ◯ | X | ◯ | ◯ | X | X |
| | Property | | | | | | | | | | | | |

*parts by weight

As shown in Table 1, in Comparative Example 1, the amount of the polyetheramine curing agent contained in the thermosetting resin composition is relatively low, and the edge coating property of the composition is inferior. In Comparative Example 2, the amount of the polyetheramine curing agent contained in the thermosetting resin composition is relatively high, and the viscosity stability of the composition is inferior. In Comparative Example 3, the amount of the epoxy silane coupling agent contained in the thermosetting resin composition is relatively low, and the viscosity stability of the composition is inferior. In Comparative Example 4, the amount of the epoxy silane coupling agent contained in the thermosetting resin composition is relatively high, and the edge coating property of the composition is inferior. In the thermosetting resin composition of Comparative Example 5, the amount of the polyetheramine curing agent is relatively high and the amount of the epoxy silane coupling agent is relatively low, and both of the viscosity stability and the edge coating property of the thermosetting resin composition are inferior.

In Examples 1-7, all of the thermosetting resin compositions contain the polyetheramine curing agent in an amount ranging from 1 to 10 parts by weight and the epoxy silane coupling agent in an amount ranging from 10 to 50 parts by weight based on 100 parts by weight of the epoxy resin. Both the viscosity stability and the edge coating property of the thermosetting resin composition of Examples 1-7 are enhanced.

Therefore, it has been demonstrated that improved viscosity stability and edge coating property can be obtained by the thermosetting resin composition of the present invention in which the amounts of the polyetheramine curing agent and the epoxy silane coupling agent are specifically controlled.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A thermosetting resin composition, comprising:
an epoxy resin;
a polyetheramine curing agent; and
an epoxy silane coupling agent;
wherein said polyetheramine curing agent is in an amount ranging from 1 to 10 parts by weight and said epoxy silane coupling agent is in an amount ranging from 10 to 50 parts by weight based on 100 parts by weight of said epoxy resin.

2. The thermosetting resin composition as claimed in claim 1, wherein said polyetheramine curing agent is selected from the group consisting of:
a curing agent of formula (I): 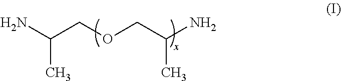
wherein x is an integer ranging from 1 to 60;
a curing agent of formula (II): 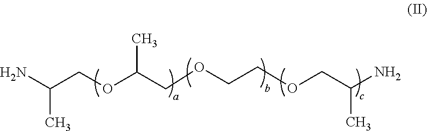
wherein
a, b, and c are respectively a positive integer,
1≦b≦50, and
1≦a+c≦10;
a curing agent of formula (III): 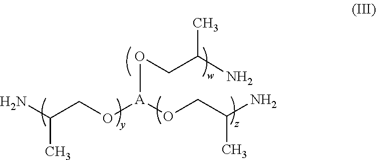
wherein
A represents a triol core having 3 to 6 carbon atoms and capable of oxyalkylation,
w, y, and x are respectively a positive integer, and
an average of a sum of w, y, and x ranges from 4 to 100; and
combinations thereof.

3. The thermosetting resin composition as claimed in claim 1, wherein said polyetheramine curing agent has a weight average molecular weight ranging from 200 to 5000.

4. The thermosetting resin composition as claimed in claim 1, wherein said polyetheramine curing agent is in an amount ranging from 2 to 9 parts by weight and said epoxy silane coupling agent is in an amount ranging from 12 to 45 parts by weight based on 100 parts by weight of said epoxy resin.

5. The thermosetting resin composition as claimed in claim 4, wherein said polyetheramine curing agent is in an amount ranging from 3 to 8 parts by weight and said epoxy silane coupling agent is in an amount ranging from 15 to 40 parts by weight based on 100 parts by weight of said epoxy resin.

6. The thermosetting resin composition as claimed in claim 1, further comprising a filler.

7. An adhesive layer obtainable by heating the thermosetting resin composition of claim 1.

8. A display element comprising the adhesive layer of claim 7.

9. A method for making a display element, comprising the steps of:
providing two substrate units;
applying the thermosetting resin composition of claim 1 on an edge portion of at least one of the substrate units;
laminating the substrate units in a manner that the thermosetting resin composition is disposed between the substrate units; and
curing the thermosetting resin composition by heating.
